(19) United States
(12) Patent Application Publication
(10) Pub. No.: US 2016/0306421 A1
(43) Pub. Date: Oct. 20, 2016

(54) FINGER-LINE BASED REMOTE CONTROL

(71) Applicant: International Business Machines Corporation, Armonk, NY (US)

(72) Inventors: Sandro Piccinini, Rome (IT); Sarbajit K. Rakshit, Kolkata (IN)

(21) Appl. No.: 14/688,034

(22) Filed: Apr. 16, 2015

(51) Int. Cl. G06F 3/01

(52) U.S. Cl. CPC G06F 3/014

(57) ABSTRACT

Controlling a peripheral device by receiving data from a ring device that indicates that a user touched their thumb to a region of their finger. Both the thumb and the finger are one hand of the user. Identifying a command that is associated with the region of the finger that was touched. Wirelessly passing the command to a peripheral device. The command controls a function of the peripheral device.

### BACKGROUND OF THE INVENTION

The present invention relates generally to the field of communication technology, and more particularly to an input device worn by a user.

The modern communications era has brought about a tremendous expansion of wireline and wireless networks. Computer networks, television networks, and telephone networks are experiencing an unprecedented technological expansion fueled by consumer demands. Together with these expanding network capabilities and communication speeds, the devices that use these networks have experienced tremendous technological steps forward in capabilities, features, and user interface. Such devices may also use accessories such as remote input devices, wireless headsets or wired headsets with limited functional capabilities. Devices communicating via these networks may be used for a wide variety of purposes including, among other things, Short Messaging Services (SMS), Instant Messaging (IM) service, E-mail, voice calls, music recording/playback, video recording/playback, and internet browsing. Such capabilities have made these devices very desirable for those wishing to stay in touch and make themselves available to others.

Hands free devices have increased in popularity through the advent of laws prohibiting hand-held mobile device usage when driving a vehicle and the desire of users to communicate without monopolizing the use of a hand. Such devices may include a wired headset that is physically connected to a mobile device or a wireless headset that is connected to a mobile device through a wireless Personal Area Network connection. Additionally, wireless vehicle accessories may allow a user to use a speaker and microphone within a vehicle to communicate over their mobile device. Such devices may enable the user of a mobile device to carry on a voice call through their mobile device without having to hold the device. Further, a wireless headset or vehicle accessory may allow a user to carry on a voice call while the device remains in a purse, pocket, glove box, or other nearby location that may not be readily accessible. Such wireless devices or headsets and vehicle accessories using other communications protocols may have limited functionality with respect to a device to which they are paired or synchronized.

### SUMMARY

Embodiments of the present invention provide a method, system, and program product to control a peripheral device. The method comprising: responsive to a determination by a ring device that a user of the ring device has issued a command by touching a thumb of the user to a region of a finger of the user, identifying, by a processor of the ring device, a command that is associated with the region of the finger, wherein both the thumb of the user and the finger of the user are of a single hand of the user; and wirelessly passing, by a processor of a ring device, the command to a peripheral device, wherein the command controls a function of the peripheral device.

### BRIEF DESCRIPTION OF THE SEVERAL VIEWS OF THE DRAWINGS

FIG. 1 is a functional block diagram illustrating a user interface environment, in accordance with an exemplary embodiment of the present invention.

FIG. 2 illustrates a ring that functions as an input device that is worn on the thumb of a user, in accordance with an exemplary embodiment of the present invention.

FIG. 3 illustrates operational processes of a ring program, executing on a ring that functions as an input device that worn on the thumb of a user within the environment of FIG. 1, in accordance with an exemplary embodiment of the present invention.

FIG. 4 illustrates operational processes of a device program, on a receiving device within the environment of FIG. 1, in accordance with an exemplary embodiment of the present invention.

FIG. 5 depicts a block diagram of components of the computing device executing the ring program, in accordance with an exemplary embodiment of the present invention.

### DETAILED DESCRIPTION

Embodiments of the present invention recognize the remote control-of and/or interaction-with electronic-devices such as computers; home-entertainment-systems; media-centers; televisions; DVD-players; VCR-players; music systems; displays; appliances; security systems; games/toys; or any other type of device that user(s) may control or interact with.

Embodiments of the present invention recognize that some remote controls are perceived by users to be complex to use due, in part, to the large number of control-buttons they have. For example, some remotes have over fifty physical buttons. In addition, some remotes utilize multi-button functional combinations, which can further increase the level of complexity perceived by a user. In some cases, many users do not know what all the buttons do or how to use them. At any given time, only a few of the buttons may be useful to the user and the presence of other buttons can increase the difficultly for a user trying to find a button for a desired function.

Embodiments of the present invention recognize an increase in the quantity of buttons often leads to a decrease in button size. In some cases, small buttons are tightly packed onto a remote. These size constraints can increase the perceived level of difficulty of using the remote for some users. For example, a user with large fingers has more difficulty using a remote with thirty small tightly packed buttons when compared to another remote of equal size that has twelve larger buttons that are more spread out. In another example, a user has difficulty reading small size button labels on a remote with thirty small tightly packed buttons when compared to another remote of equal size that has twelve larger buttons and larger labels that are more spread out. In many cases, small size buttons often result in text-abbreviations or small-icons that some users have difficulty seeing and/or deciphering. In addition, in some scenarios, a user may be using a remote-control in a darkened room, where limited ambient light can increase the perceived level of difficulty to use that remote, e.g., as perceived by a user in the darkened room that is seeking to find a desired button.

Embodiments of the present invention recognize that, in many applications, the user is required to continually switch between nearsighted tasks (of looking at the control buttons) and farsighted tasks (of looking up at a display) which may present range of focus/correction problems for certain users.

Embodiments of the present invention recognize that if the user activates the wrong button (i.e., a button/function that the user did not wish to activate), the remote-control may enter a mode that the user doesn't know how to get out of. In some scenarios, this results in changes being made to a set-up configuration that the user may not know how to correct or must expend great effort to determine how to correct.

Embodiments of the present invention recognize that the user must use specific navigation buttons (for example, up, down, right, and left directional buttons) to move the selection-point on the screen. In some cases, the user often needs to press the navigation buttons multiple times and in a particular order to arrive at the desired selection point. In addition, the user may need to alternately look up to the screen and then back down to the navigation and/or other control buttons multiple times; to check that the navigation movements or control actions are happening as expected and that the intended action is occurring.

Embodiments of the present invention recognize associating numbers with specific areas of the finger. Embodiments of the present invention provide a device that allows a user to select a number by touching a thumb to a particular area of the finger. Embodiments of the present invention provide a device that interprets a user touching a thumb to a particular area of the finger as a selection of a number associated with that area of the finger.

The present invention will now be described in detail with reference to the Figures.

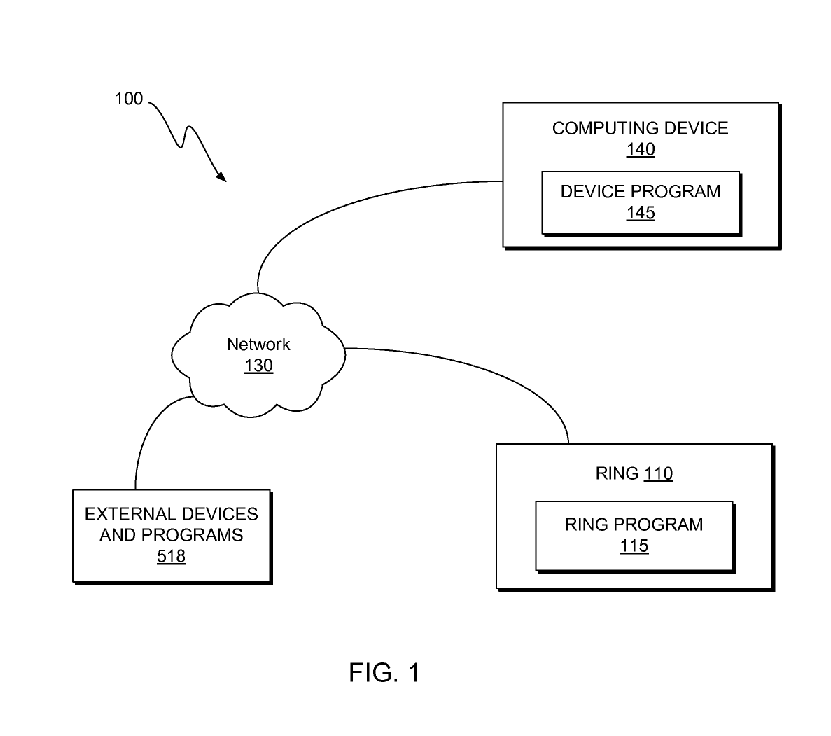

FIG. 1 is a functional block diagram illustrating a user interface environment, generally designated 100, in accordance with one embodiment of the present invention. User interface environment 100 includes ring 110 and computing device 140 connected over network 130. Ring 110 includes ring program 115 and computing device 140 includes device program 145.

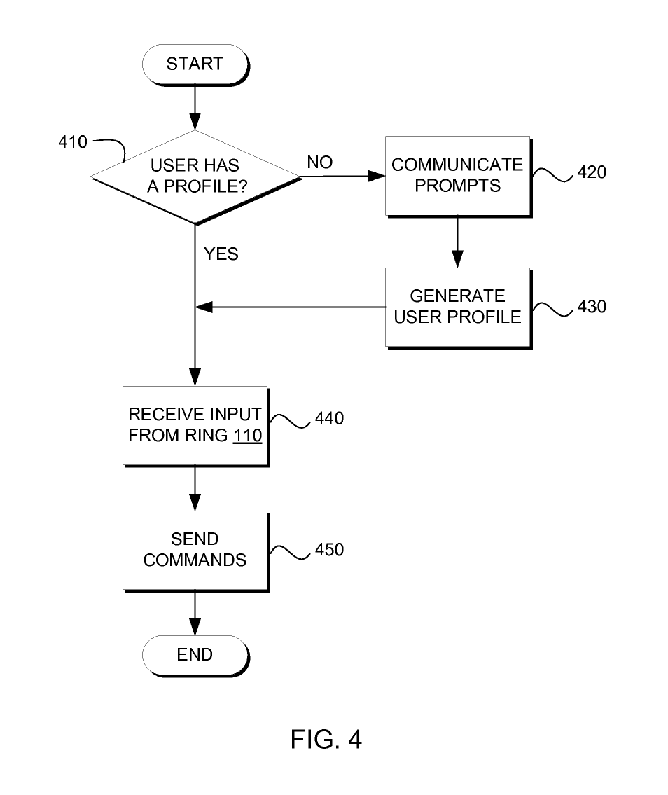

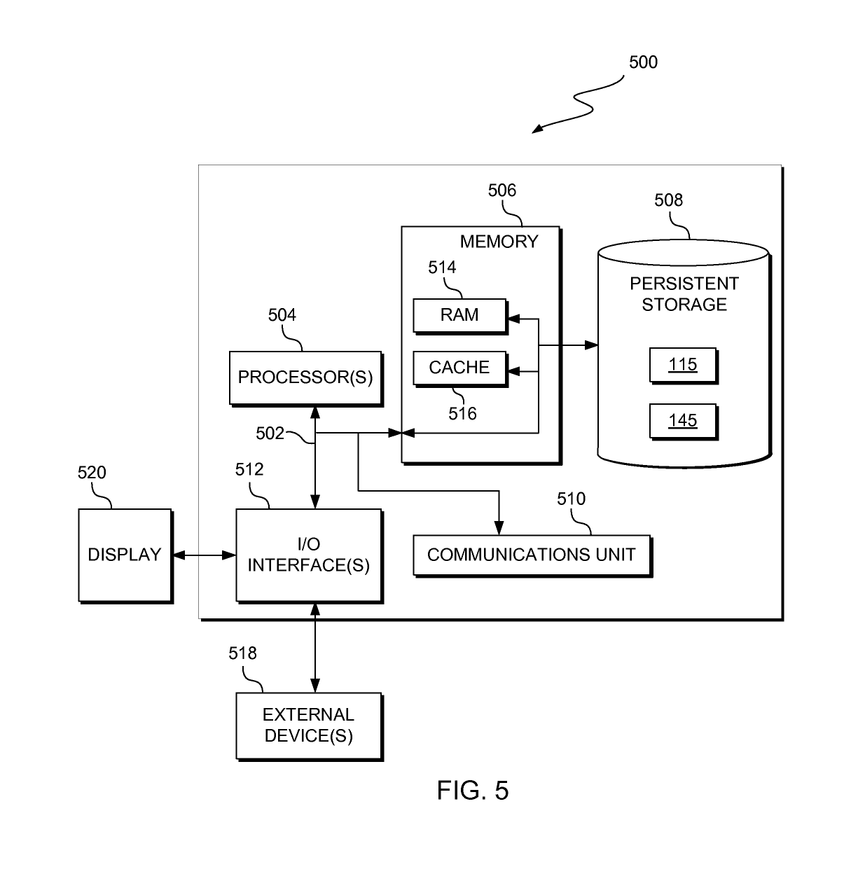

In various embodiments of the present invention, computing device 140 is a computing device that can be a standalone device, a server, a laptop computer, a tablet computer, a netbook computer, a personal computer (PC), or a desktop computer. In another embodiment, computing device 140 represents a computing system utilizing clustered computers and components to act as a single pool of seamless resources. In general, computing device 140 can be any computing device or a combination of devices with access to ring 110 and device program 145 and is capable of executing device program 145. Computing device 140 may include internal and external hardware components, as depicted and described in further detail with respect to FIG. 4. In this embodiment, computing device has access to various devices and programs that a user may wish to control using ring 110. For the sake of simplicity, specific devices and programs are not shown in FIG. 1 but are represented by external devices and programs 518 being connected to computing device 140 via network 130. As described below and shown in FIG. 5, such devices include one or more respective programs (not shown) are represented by external devices and programs 518 and are in communication with computing device 140. In some embodiments, such external devices 518 include devices such as multimedia systems, for example televisions and stereos, as well as computing systems such as laptops, personal computers, and Smartphones, and their associated software.

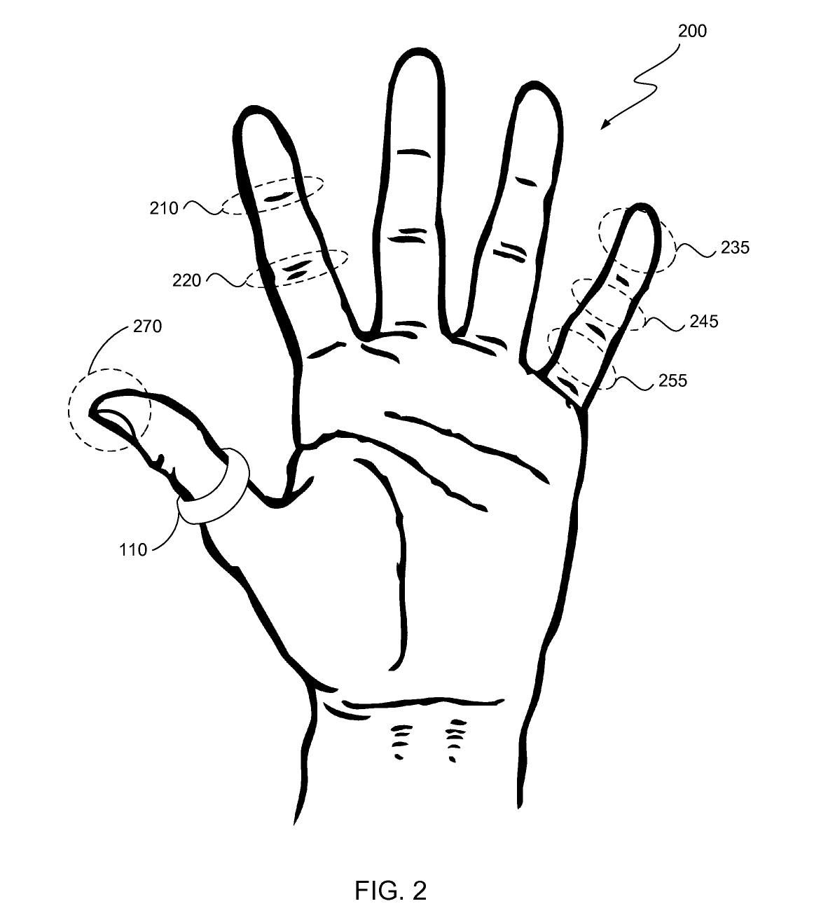

FIG. 2 illustrates ring 110 that functions as an input device worn on the thumb of a user, in accordance with an exemplary embodiment of the present invention. Ring 110 includes communication hardware and software, such as a communication device configured for communicating via wireless Personal Area Networks (WPANs) (such as via the IEEE 802.15 or 802.11 standards), infrared (IrDA), ultra wideband (UWB), and the like. While not shown, such a communications device may comprise a processor, transceiver, transmitter, receiver, or the like embedded within ring 110 and an antenna, in communication therewith, which may be disposed about the perimeter of ring 110. Ring 110 may further include processing hardware and software for processing data (e.g., input data, sensor data, etc.) such as a processor or circuitry with the processing capabilities necessary for implementation of embodiments of the present invention. Ring 110 also includes sensors for detecting the movement and position of the thumb of the user that is wearing ring 110. For example, ring 110 includes sensors to detect bioelectric signals generated by muscles contracting in the thumb of the user. As another example, one or more accelerometers, gyroscopes or other devices detect movement of the thumb of the user while wearing ring 110.

The depicted embodiment includes ring 110 that is a ring-type device configured to be worn by a user on a thumb. While the illustrated embodiments are primarily directed to embodiments that may be of a ring-type, devices according to the present invention may be of a variety of shapes and sizes that are configured to be worn or attached to a user on a device-bearing part of the user. For example, a bracelet-type embodiment may be configured to be worn around a user's wrist, arm. As such, example embodiments of the present invention may be configured in any number of potential configurations that permit them to be worn or otherwise attached to a user. Embodiments of the present invention may benefit from an appearance that does not substantially deviate from that of what may be a conventional ring that is worn as jewelry or ornamentation. While some example embodiments may include elements that clearly indicate the user input device is a functional device rather than strictly ornamental, other embodiments that do not clearly indicate that they are functional devices may be preferred for discretion.

As is illustrated in FIG. 2, the finger-lines are lines or creases in the skin on the bottom, i.e., palm side, surface of a finger that form at the point where the joint of that finger bends. Also note that there are pads of flesh (herein called “pads”) between these finger-lines. In FIG. 2 two such finger-lines are indicated by dashed circles 210 and 220 and three such pads are indicated by dashed circles 235, 245 and 255. Note that, to simplify FIG. 2, not all finger-lines and pads are indicated in FIG. 2. In general, the palm side surface of each finger (i.e., the palm side of hand 200 as shown in FIG. 2) is divided into a plurality of regions that are touchable by the tip of the thumb wearing ring 110. FIG. 2 also indicates the tip of the users thumb by dashed circle 270, note that the thumb is wearing ring 110. For many users, it is possible to touch most of these finger-lines and pads with an upper portion or “tip” of their thumb. In this embodiment, certain finger-lines and pads are assigned numerical values. In some embodiments, the finger-lines and pads constitute a grid for user commands, where each pad or finger-line is a point on the grid is assigned to and corresponds to a specific user command. In one embodiment, a finger represents a numerical range. In one such embodiment, certain finger-lines and pads are used to mark the start and end of a numerical range. In such embodiments, ring program 115 is configured to determine a value associated with a given touch of the thumb to the finger based on a point of contact of the thumb and finger in the space between at least two regions of the finger. For example, the space between pad 255 and 235 represents a range of numbers with pad 255 representing the start of the range with a value of one hundred and pad 235 representing the end of that range with a value of five hundred. As such, a user can select a number within that range by touching the tip of their thumb to a spot between pad 255 and pad 235, which is the point of contact between the thumb and finger in the space between pad 255 and pad 235. Therefore, such an embodiment allows a user to select intermediate numbers that exist between two other numbers. For example, if finger-line 220 represents a value of five and finger-line 210 represents a value of ten, then a user is able to select a value of six, seven, eight or nine by touching an area of the finger that is between finger-line 220 and finger-line 210. In this example the space between finger-line 220 and finger-line 210 is segmented into four equal portions and each portion is assigned a numerical value (i.e., the numbers are in numerical order according to their value) of either six, seven, eight or nine with six being closest to finger-line 220 and nine being closest to finger-line 210.

In one embodiment, the touching of a pad or finger-line by tip of thumb 270, by a user wearing ring 110, results in ring 110 detecting the movement and interpreting the motion as a selection of the corresponding numerical value. In other embodiments, certain finger-lines and pads are assigned non-numerical values. For example, certain finger-lines and pads are assigned to one or more devices and/or programs that are often accessed by the user. In other embodiments, certain finger-lines and pads are assigned to often use commands to control certain device and programs. For example, two finger pads are respectively assigned a “volume increase” command and a “volume decrease” command for a headset device. Similarly, two other finger pads are respectively assigned a “place call” and an “end call” command for a smartphone device.

In this exemplary embodiment, ring program 115 is stored on ring 110 and device program 145 is stored on computing device 140. However, in other embodiments, ring program 115 and device program 145 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between ring program 115, ring 110, device program 145, and receiving device 145, in accordance with a desired embodiment of the present invention.

In various embodiments, ring 110 includes one or more sensors to identify different stresses generated by the thumb muscle of the thumb wearing ring 110. In one embodiment, ring 110 detects touches of (i.e., contact between) the tip of the thumb of the user and a point in a finger-line. In one embodiment, ring 110 detects touches of the thumb of the user to specific areas based on data from sensors that detect the electrical signals of muscle contractions and accelerometers to detect direction of movement and acceleration of the thumb. Ring 110 then determines the appropriate number to be selected based on that contraction pattern. In one embodiment, a user can provide any type of gesture to select the number “0”, because “0” is not selectable using a finger-line. For example, in one embodiment, a wave of the hand is used to select “0”. In one embodiment, ring 110 detects stress in thumb muscle and accordingly calculates which point on which finger has been touched. In one embodiment, the user maps number combination to specific devices or programs. For example, in one embodiment, a number sequence to access a telephone type device is “131”, a television is “225”, and an Internet browsing program is “4165” where “416” indicates the computing device to be accessed and the “5” indicates the program to be activated. In one embodiment, if a main menu for a device is selected, for example device program 145 of computing device 140 is selected and as a result a user is provided the option to enter additional number sequences within a predefined time limit to access other programs and make selections.

In one embodiment, device program 145 is an additional pluggable component that is combined with a ring type wearable device that is able to collaborate with a stress sensor to translate thumb movements (e.g., touching finger-lines with the thumb) to appropriate commands. In such an embodiment, device program 145 is configured to register one or more devices (for example, computing device 140 or external devices and programs 518) to be controlled by ring 110 and for each of the devices ring 110 is profiled with a different user role, i.e., level of authorization. For example, in one family, the father and mother have administrative role and privileges for a television device and other relatives, such as their children, have standard user role. In a case in which multiple ‘rings’ are simultaneously acting toward the same device (or in a configurable timeframe) a hierarchical policy is applied such that the command from the user with higher privilege is performed and not overridden by users with lower levels of privilege in the designed timeframe. For example, in the example above, if the father lowers the volume of television the son cannot increase it for a predetermined amount of time (e.g., twenty seconds). In one embodiment, there is a hierarchy of command with a group of rings. For example, if a first ring has a low level of permissions, then some commands require approval from a higher ranking second ring in order to be executed by device 140.

In some embodiments and scenarios, a form of content control is utilized where certain users of rings are restricted from accessing certain content unless permissions is granted by a “master” ring. In such an embodiment and scenario, a master ring is a ring of a user that has the appropriate level of authorization to permit the other user access to the content. In some embodiments, a set of rules are used to organize authorization and authority to control such access and granting of permissions for devices, such as device 140, to execute commands that are issued by certain rings. For example, in one embodiment, a parent grants authorization to the ring of a child to send commands to a television allowing the child to watch certain television channels. However, this access is limited by certain rules included in the rule set included as part of device program 145. Therefore, the child is allowed to access only certain types of programming based on the permission granted by their parent. If the child attempts to access content that they are not authorized to view, then the ring (ring 110) of the parent activates an oscillating weight mechanism included in the ring to create a vibration that alerts the parent to the attempted access. In one embodiment, device program 145 sends an alert to a visual display that is viewable by the parent. The alert includes information such as the time, the date, the identity of the child, and the content that the child was attempting to access.

In one embodiment, device program 145 is configured to learn from experience. In other words, device program 145 includes programming that generates records of circumstances and the actions initiated in response to those circumstances. Device program 145 is configured to access these records and identify patterns of behavior and apply those same user initiated actions to those same circumstances when those circumstances occur again. For example, in one embodiment, device program 145 identifies the instances of an incoming phone call and a user initiated response of lowering the volume of the television to a volume setting of “2”. In response, device program 145 creates a rule that automatically lowers the volume of devices to a volume that is equivalent to the television volume “2” setting, when later instances of an incoming phone call occur. As such, when an incoming phone call is identified by device program 145, device program 145 lowers the volume of all active audio devices to the volume setting of “2” of the television. In some embodiments, device program 145 prompts the user to confirm a rule before that rule is enabled. For example, device program 145 prompts the user to confirm the lowering of the volume to the volume setting of “2” of the television if an incoming phone call is identified by device program 145.

In one embodiment, device program 145 is configured to automatically perform rule generation after reaching a specific threshold number of instances have occurred. For example, device program 145 is configured to automatically perform rule generation after ten user responses to incoming phone calls have been logged. In another embodiment, device program 145 is configured to automatically perform rule generation after a predetermined period of time has elapsed. For example, data is collected over a period of three weeks and then analyzed to identify relationships between types of incidents, such as incoming phone calls, and user responses to those incidents.

In one embodiment, a one-time training session is required for each user in order to calibrate the sensor input from ring 110. As such, a user wearing ring 110 is prompted by device program 145 to touch various finger-lines and pads between two finger-lines such that device program 145 is able to map sensor data sent by ring 110 to the corresponding numerical input. In one embodiment, to select a number, a user wearing ring 110 bends their thumb wearing ring 110 and touches the required finger-line or the pad between two finger-lines. Device program 145 records the sensor data pattern of that touch and movement. Device program 145 associates that pattern with a number or input. In this manner, each user is able to personalize and configure both ring 110 and device program 145 to their own specific needs. In some scenarios and embodiments, such configuration also includes configuration to control select external devices and programs.

After the initial set-up learning process is complete a user can then access a specific device or feature by touching a sequence of finger-lines and pads between the finger-lines within a predefined configurable time. Input that occurs beyond that time is considered as separate input. For example, a user wants to select “146”, as such the user touches the finger-lines in sequence within a predefined time that correspond to the number “146”. If the user selects the numbers too slowly (i.e., above a time threshold), then device program 145 interprets each input number as an individual number, i.e., “1”, “4”, “6”. In some embodiments, the time threshold for number input is configurable by the user.

In one embodiment, the number will be executed based on the selection of a device (for example, a specific computing device 140) and a program that is installed on that device. For example if a smartphone is selected, then upon determining the selection of “123”, a phone call is established with a specific friend of the user. However, if the user selected the television using the input of code “505”, then device program 145 interprets the selection of “123” to be a user selection of channel 123 on the television.

In one embodiment, ring 110 is configured to detect a variety of non-thumb based gestures. As such, the user can eliminate or cancel any previously selected number (i.e., a command) with a type of gesture. For example, a wave of a hand is used to indicate a user initiated cancelling of a previously selected command. In one embodiment, the user defines such gestures as part of the initial set-up process for device program 145.

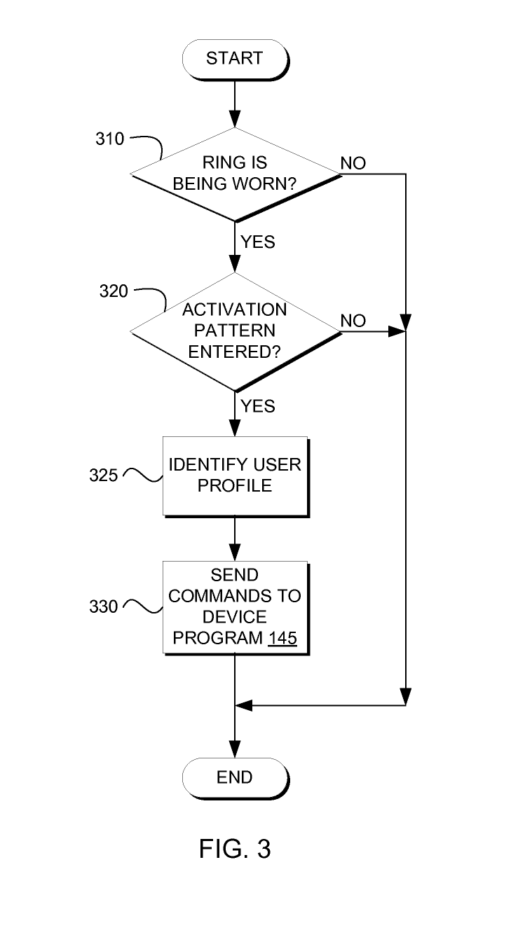

FIG. 3 illustrates operational processes of ring program 115, executing on ring 110 that functions as an input device that is worn on the thumb of a user within the environment of FIG. 1, in accordance with an exemplary embodiment of the present invention.

In decision process 310, ring program 115 determines whether sensor data from the sensors of ring 110 indicate that ring 110 is currently being worn by a user. For example, ring 110 includes a heat sensor and heart rate sensor that are configured to detect whether ring 110 is being worn by detecting the heart beat and heat of a user. If ring program 115 determines that the sensor data from the sensors of ring 110 indicates that ring 110 is not currently being worn by a user (decision process 310, NO branch), then ring program 115 enters a “standby mode” until a predetermined period of time has elapsed at which point ring program 115 ends execution, unless ring program 115 determines that new sensor data from the sensors of ring 110 indicate that ring 110 is currently being worn by a user (decision process 310, YES branch).

If ring program 115 determines that the sensor data from the sensors of ring 110 indicate that ring 110 is currently being worn by a user (decision process 310, YES branch), then ring program 115 determines whether an activation pattern has been entered by the user in decision process 320. In this embodiment, a user activates the use of ring 110 by entering in a sequence of numbers or otherwise entering a pattern of movement. If ring program 115 determines that an activation pattern has not been entered by the user (decision process 320, NO branch), then ring program 115 enters a “standby mode” until a predetermined period of time has elapsed at which point ring program 115 ends execution, unless ring program 115 determines that an activation pattern has been entered by the user during the “standby mode” time period (decision process 320, YES branch).

If ring program 115 determines that an activation pattern has been entered by the user (decision process 320, YES branch), then, based on the input pattern, ring program 115 identifies a user profile that is associated with that user in process 325. For example, ring program 115 of ring 110 includes user profiles for three members of a family. Each family member has their own activation pattern. When ring program 115 identifies that an activation pattern has been entered, ring program 115 retrieves the user profile that is associated with that pattern. In this embodiment, each user profile includes sensor data patterns that correspond to the various numbers that are authorized as input to device program 145 by the user.

In some cases, the user is a new user of ring 110. In such cases, a profile may not exist for that user. Therefore, in this embodiment, ring program 115 includes a default activation pattern. If ring program 115 identifies that the default activation pattern has been entered by the user, then ring program 115 initiates communication with device program 145. In some embodiments and scenarios, device program 145 sends a series of prompts to the user and in response, the user interacts with ring 110 such that ring 110 generates sensor data that is sent to device program 145. Device program 145 uses this data to generate a user profile for the user and sends this data to ring 110. Ring program 115 saves a copy of that user profile for future use and reference. In this embodiment, reception of a new user profile leads to ring program 115 identifying that profile as the profile of the user currently using ring 110.

In process 330, ring program 115 sends commands to device program 145 based on user input. In this embodiment, ring program 115 receives sensor data from the sensors of ring 110, ring program 115 matches that sensor data to corresponding numbers based on the user profile and then transmits the number(s) to device program 145.

FIG. 4 illustrates operational processes of a device program 145, on a receiving device within the environment of FIG. 1, in accordance with an exemplary embodiment of the present invention.

In decision process 410, device program 145 determines whether a user wearing ring 110 has a user profile that is associated with that user based on a signal received from ring 110 based on the user entering an activation pattern. For example, a “set up” activation pattern is entered by a user. As a result, device program 145 determines that the user wearing ring 110 does not have a user profile. If device program 145 determines that a user wearing ring 110 does not have a user profile (decision process 410, NO branch), then device program 145 enters a “learning mode” in process 420. Device program 145 generates a “blank” user profile that includes a user identification, for example, each user profile includes a serial number that is automatically generated and associated with the profile. In process 420, device program 145 communicates a series of prompts to the user. The user responds to the prompts thereby providing input to ring 110, which passes this data to device program 145. In process 430, device program 145 uses the data from ring 110 to generate the user profile for the user and sends this profile to ring 110. Note that ring 110 saves a copy of that user profile for future use and reference. In some embodiments, device program 145 retains a copy of the user profile and is configured to update other rings (such as new or additional ring 110 type devices) in the event that a new ring 110 is added to the environment of FIG. 1.

If device program 145 determines that a user wearing ring 110 does have a user profile (decision process 410, YES branch), then device program 145 enters a “command receiving” mode in process 440. In process 440, device program 145 receives user input from ring 110 in the form of numerical input that is generated by the user touching their thumb wearing ring 110 to a finger-line or a pad between two finger-lines. Device program 145 uses this numerical input (i.e., user provided commands) to identify a device that is to be controlled or a program included by that device that is to be controlled. In process 450, device program 145 sends commands to the device or program based on the received user commands. The user thereby controls the device or program using ring 110.

In one embodiment, ring 110 includes the functionality of computing device 140 and device program 145. In certain such embodiments, ring 110 is configured to interact with, i.e., send commands to, various peripheral devices in a similar manner to computing device 140.

FIG. 5 depicts a block diagram, 500, of respective components of ring 110 and computing device 140, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Ring 110 and computing device 140 include a communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Ring program 115 and device program 145 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 130. In these examples, communications unit 510 includes one or more network interface cards. Communications unit 510 may provide communications through the use of either or both physical and wireless communications links. Ring program 115 and device program 145 may be downloaded to persistent storage 508 through communications unit 510.

I/O interface(s) 512 allows for input and output of data with other devices that may be connected to ring 110 and computing device 140. For example, I/O interface 512 may provide a connection to external devices 518 such as a keyboard, keypad, a touch screen, and/or some other suitable input device. In the case of ring 110, ring 110 includes one or more sensors to detect the movement and location of a thumb of a user of ring 110. External devices 518 can also include portable computer-readable storage media such as, for example, thumb drives, portable optical or magnetic disks, and memory cards. Software and data used to practice embodiments of the present invention, e.g., ring program 115 and device program 145, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) certain terms used herein may be subject to trademark rights in various jurisdictions throughout the world and are used here only in reference to the products or services properly denominated by the marks to the extent that such trademark rights may exist.

What is claimed is:

1. A method of controlling a peripheral device, the method comprising:
responsive to a determination by a ring device that a user of the ring device has issued a command by touching a thumb of the user to a region of a finger of the user, identifying, by a processor of the ring device, a command that is associated with the region of the finger, wherein both the thumb of the user and the finger of the user are of a single hand of the user; and
wirelessly passing, by a processor of a ring device, the command to a peripheral device, wherein the command controls a function of the peripheral device.

2. The method of claim 1, wherein the ring device includes one or more sensors configured to measure movement of the thumb of the user, and wherein the thumb of the user is wearing the ring device.

3. The method of claim 2, the method including:
determining, by a processor of a ring device, whether the user has issued the command by touching the thumb to a region of the finger based on sensor data that was gathered by one or more sensors of the ring device.

4. The method of claim 1, wherein a surface of the finger includes a plurality of regions and at least one region of the plurality of regions is associated with a number such that touching of the thumb to the at least one region of the finger is interpreted by the ring device as a selection of the number.

5. The method of claim 1, wherein a space between at least two regions of the finger represents a range of numbers, and wherein the ring device is configured to determine a value associated with a given touch of the thumb to the finger based on a point of contact of the thumb and finger in the space between the at least two regions of the finger.

6. The method of claim 1, the method including:
responsive to the determination by the ring device that the user of the ring device has issued the command by touching the thumb of the user to the region of the finger of the user, determining whether the user has a level of authorization that is required to control the function of the peripheral device.

7. The method of claim 1, the method including:
responsive to a determination that a second user of the ring device has initiated a calibration procedure, instructing the second user to move a thumb of the second user to a region of a finger of the second user;
determining, by a processor of a ring device, a pattern of sensor data that corresponds to movement of the thumb of the second user to the region of the finger of the second user; and
generating a record that associates the pattern of sensor data with a command that is associated with the region of the finger of the second user.

8. A computer program product for controlling a peripheral device, the computer program product comprising:
one or more computer-readable storage media and program instructions stored on the one or more computer-readable storage media, the program instructions comprising:
program instructions to respond to a determination by a ring device that a user of the ring device has issued a command by touching a thumb of the user to a region of a finger of the user by identifying a command that is associated with the region of the finger, wherein both the thumb of the user and the finger of the user are of a single hand of the user; and
program instructions to wirelessly pass the command to a peripheral device, wherein the command controls a function of the peripheral device.

9. The computer program product of claim 8, wherein the ring device includes one or more sensors configured to measure movement of the thumb of the user, and wherein the thumb of the user is wearing the ring device.

10. The computer program product of claim 9, the program instructions including:
program instructions to determine whether the user has issued the command by touching the thumb to a region of the finger based on sensor data that was gathered by one or more sensors of the ring device.

11. The computer program product of claim 8, wherein a surface of the finger includes a plurality of regions and at least one region of the plurality of regions is associated with a number such that touching of the thumb to the at least one region of the finger is interpreted by the ring device as a selection of the number.

12. The computer program product of claim 8, wherein a space between at least two regions of the finger represents a range of numbers, and wherein the ring device is configured to determine a value associated with a given touch of the thumb to the finger based on a point of contact of the thumb and finger in the space between the at least two regions of the finger.

13. The computer program product of claim 8, the program instructions including:
program instructions to respond to the determination by the ring device that the user of the ring device has issued the command by touching the thumb of the user to the region of the finger of the user by determining whether the user has a level of authorization that is required to control the function of the peripheral device.

14. The computer program product of claim 8, the program instructions including:
program instructions to respond to a determination that a second user of the ring device has initiated a calibration procedure by instructing the second user to move a thumb of the second user to a region of a finger of the second user;
program instructions to determine a pattern of sensor data that corresponds to movement of the thumb of the second user to the region of the finger of the second user; and
program instructions to generate a record that associates the pattern of sensor data with a command that is associated with the region of the finger of the second user.

15. A computer system for controlling a peripheral device, the computer system comprising:
one or more computer processors;
one or more computer readable storage medium;
program instructions stored on the computer readable storage medium for execution by at least one of the one or more processors, the program instructions comprising:
program instructions to respond to a determination by a ring device that a user of the ring device has issued a command by touching a thumb of the user to a region of a finger of the user by identifying a command that is associated with the region of the finger, wherein both the thumb of the user and the finger of the user are of a single hand of the user; and
program instructions to wirelessly pass the command to a peripheral device, wherein the command controls a function of the peripheral device.

16. The computer system of claim 15, wherein the ring device includes one or more sensors configured to measure movement of the thumb of the user, and wherein the thumb of the user is wearing the ring device.

17. The computer system of claim 16, the program instructions including:
program instructions to determine whether the user has issued the command by touching the thumb to a region of the finger based on sensor data that was gathered by one or more sensors of the ring device.

18. The computer system of claim 15, wherein a surface of the finger includes a plurality of regions and at least one region of the plurality of regions is associated with a number such that touching of the thumb to the at least one region of the finger is interpreted by the ring device as a selection of the number.

19. The computer system of claim 15, wherein a space between at least two regions of the finger represents a range of numbers, and wherein the ring device is configured to determine a value associated with a given touch of the thumb to the finger based on a point of contact of the thumb and finger in the space between the at least two regions of the finger.

20. The computer system of claim 15, the program instructions including:
program instructions to respond to a determination that a second user of the ring device has initiated a calibration procedure by instructing the second user to move a thumb of the second user to a region of a finger of the second user;
program instructions to determine a pattern of sensor data that corresponds to movement of the thumb of the second user to the region of the finger of the second user; and
program instructions to generate a record that associates the pattern of sensor data with a command that is associated with the region of the finger of the second user.
